(19) United States
(12) Patent Application Publication
(10) Pub. No.: US 2013/0325616 A1
(43) Pub. Date: Dec. 5, 2013

(54) LOCATION-BASED AND CONTEXT-AWARE ADVERTISING PLATFORM

(71) Applicants: Rakesh RAMDE, Los Altos, CA (US); Amanjyot Singh JOHAR, Fremont, CA (US)

(72) Inventors: Rakesh RAMDE, Los Altos, CA (US); Amanjyot Singh JOHAR, Fremont, CA (US)

(21) Appl. No.: 13/843,478

(22) Filed: Mar. 15, 2013

Related U.S. Application Data
(60) Provisional application No. 61/689,275, filed on Jun. 1, 2012.

(51) Int. Cl. G06Q 30/02

(52) U.S. Cl. CPC G06Q 30/0261
USPC 705/14.58

(57) ABSTRACT

Techniques for serving location-based, context aware advertisements. A server receives location and contextual information associated with a user device and/or a user. One or more ads are selected from a database of ads for the user based on where the user device is located and activity of the user with the user device. Ads are then to the user device for display. The contextual information is based on user interactions with a user device. The user interactions include opening and closing applications, and input and output of the applications.

### CROSS-REFERENCES TO RELATED APPLICATIONS

This application claims priority under 35 USC 119(e) to U.S. Pat. App. No. 61/689,275, entitled LOCATION BASED CONTEXT AWARE ADVERTISING PLATFORM, by Rakesh Ramde et al., the contents of which are being hereby incorporated by reference in its entirety.

### FIELD OF THE INVENTION

The invention relates generally to electronic advertising, and more specifically, to serving advertisements based on location and context of a user device.

### BACKGROUND OF THE INVENTION

Advertisers are constantly seeking to provide more relevant advertisements (“ads”) to consumers. The more targeted an ad is to a particular demographic, the more premiums fees advertisers can charge for ad placement fees. Currently, Internet-based ads are served based on preconfigured, static information, such as gender, age, or a subject matter of a web page on which an ad is displayed. Other ads are based on internally available information. For example, a proxy server can collect information on a user's web browsing and provide ads within web pages sent by the proxy server.

Unfortunately, the ads are lacking in specificity to a particular user. First, the preconfigured ads are generic and without regard to a particular user. Second, the internal information is limited. The web browser only provides a certain aspect of information that can lead to invalid assumptions and, thus, ineffective ads.

What is needed is a robust technique for serving location-based and context aware ads, while overcoming the deficiencies of the prior art.

### SUMMARY

To meet the above-described needs, methods, computer program products, and systems for serving location-based and context-aware advertising (“ads”).

In one embodiment, a server receives location and contextual information associated with a user device and/or a user. One or more ads are selected from a database of ads for the user based on where the user device is located and activity of the user with the user device. Ads are then sent to the user device for display.

In another embodiment, a user device collects location information from a GPS unit and contextual information from a daemon or operating system on the user device. The collected information is sent to a server, and ads are received in response. The user device displays the ads.

In yet another embodiment, the contextual information is based on user interactions with a user device. The user interactions include opening and closing applications, and input and output of the applications. The user interactions can infer a context of the user (e.g., intentions and mood).

Advantageously, highly-targeted ads are provided based on a where a user is located, and on what a user is doing.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system to serve location-based and context-aware advertisements, according to one embodiment.

FIG. 2 is a more detailed block diagram illustrating a user device of FIG. 1, according to one embodiment.

FIG. 3 is a more detailed block diagram illustrating a context advertising server of FIG. 1, according to one embodiment.

FIG. 4 is a high-level flow diagram illustrating a method for serving location-based and context-aware advertisements in a server, according to one embodiment.

FIG. 5 is a flow diagram illustrating a method for displaying location-based and context-aware advertisements in a user device, according to one embodiment.

FIG. 6 is a block diagram illustrating an exemplary computing device, according to one embodiment.

### DETAILED DESCRIPTION

The present invention provides methods, computer program products, and systems for serving location-based and context-aware advertisements (“ads”). Generally, ads are selected based on where a user is located and what a user is doing. The context of what a user is doing is inferred by activities with the user device such as which applications are being accessed, an intensity of interaction with the activity (e.g., constant data entry or intermittent, or listening to loud music or soft music). Context information collected provides insight for ad selection related to user intentions, moods, failures, successes, upcoming appointments, travel plans, and the like.

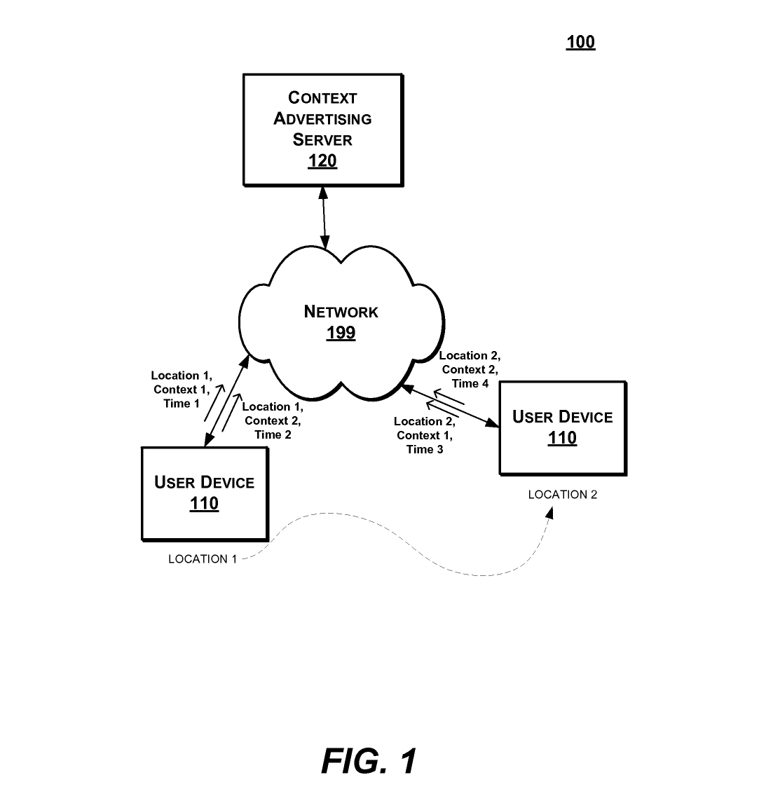

Advertising Systems (FIGS. 1-3)

FIG. 1 is a high-level block diagram illustrating a system 100 to create social networking connections with gestures, according to one embodiment. The system 100 comprises user device 110 at various locations and a context advertising server 120. Each of the components is coupled in communication via network 199. The data flow starts at the user device 110 sending location and context information to the context advertising server 120 which, in turn, sends ads to the user device 110 for display.

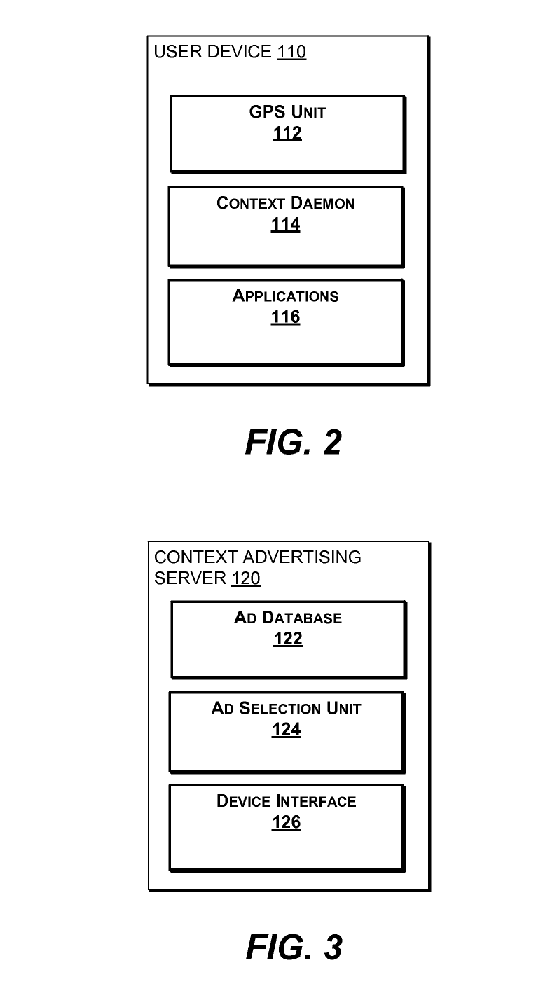

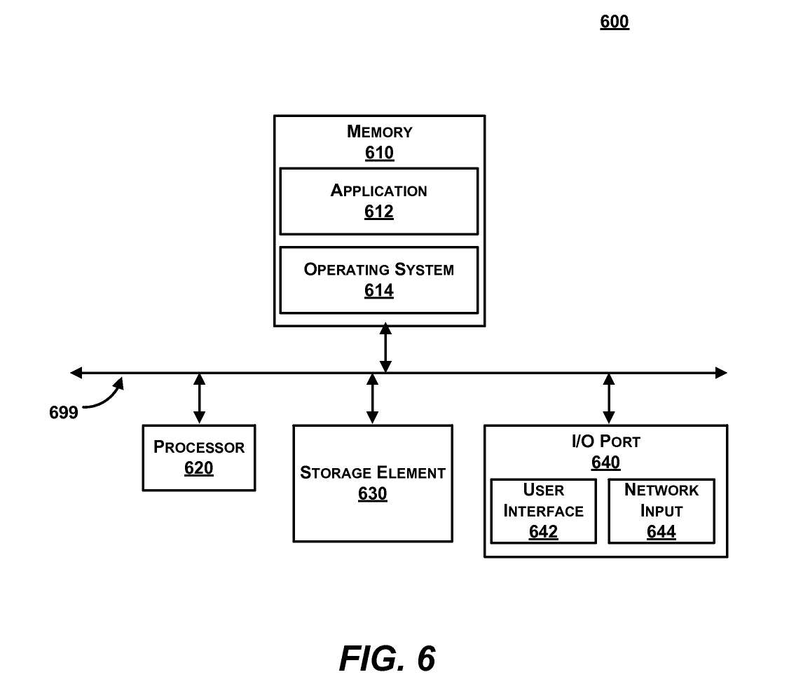

The user device 110 can be, for example, a mobile device, a smart phone, a tablet computer, a personal computer, an Internet appliance, or any other appropriate computing device as described in FIG. 6. In operation, the user device 110 collects location and context information about a user and user device, and displays responsive advertisements. At a first time, the user device is at a first location and is characterized by a first context. At a second time, the user device at the first location is now characterized by a second context because of current activities of a user. For example, a user may have transitioned from more serene activities such as reading a digital book, to more invigorating activities such as listening to dance music at a loud volume, while remaining at the same location. Different ads can be served accordingly. Moreover, at a third time, the user device has moved to a second location and is characterized by a first context. The first context of the second location may be the same as the first context as the first location, but the ads may be different due to the change in location (or the change in time). At a fourth time, the user device at the second location is now characterized by a second context. Again, different ads can be served accordingly. Embodiments of the user device 110 are discussed in more detail below in association with FIG. 2.

The context advertising server 120 can be one or more server blades, or any appropriate computing device described herein executing, for example, an Apache type of server software, including the general computing device of FIG. 6. When location and context information is received from the user device 110, one or more appropriate ads are selected and sent to the user device 110 for display. To do so, the context advertising server 120 can search ads using location and context information directly, or can infer search terms from a user context such as intentions or mood. Embodiments of the user device 110 are discussed in more detail below in association with FIG. 3.

FIG. 2 is a more detailed block diagram illustrating the user device 110 of FIG. 1, according to one embodiment. The user device 110 includes a GPS unit 112, a context daemon 114 and applications 116, among other components. The components can be hardware, non-transitory computer executable source code, or a combination of hardware and software.

The GPS unit 112 can determine a current location of a device by processing information received from geophysical satellites. In alternative embodiments, other processes can be used to determine location, such as IP address, cell phone tower triangulation, location sensors, and the like.

The context daemon 114 tracks user activity and interactions with a user device. The context daemon 114 can execute as a background process that logs applications opened and closed, how long applications are used, times of use, inputs and outputs of applications (e.g., Internet searches and results, documents opened and document contents), and installation of new applications or deletion of applications. General, or aggregate activities can be logged such as downloading applications, downloading music, uploading photos, and the like. In another embodiment, the context daemon 114 is integrated with an operating system. The context daemon 114 (or processes on a server) can use logic to determine characteristics of a user such as intentions, moods, failures, successes, upcoming appointments, travel plans, and the like. Many more types of characteristics are possible.

The applications 116 can be software executed and stored locally on a user device or remotely. A patch can be added to the applications 116 for more direct communication. Examples of the applications 116 include a web browser, a multimedia player, a document generator or viewer, a spreadsheet application, social media, a text message application, a phone call application, an application to review businesses (e.g., Yelp), and more.

FIG. 3 is a more detailed block diagram illustrating the connections server 120 of FIG. 1, according to one embodiment. The connections server 120 includes an ad database 122, an ad selection unit 124, and a device interface 126, among other components. The components can be hardware, non-transitory computer executable source code, or a combination of hardware and software.

The ad database 122 can be stored locally or remotely from the context advertising server 120. The ad database 122 stores a volume of indexed advertisements. The ads can be images (e.g., GIF or JPG), video (e.g., MPG or MP4), text or documents (e.g., PDF or rich text), audio (e.g., MP3 or WAV), or any other type of media displayable on a user device. The advertisements can be embedded in a web page, an application running on a device, a desktop, or other areas of display accessible by the operating system.

The ad selection unit 124 determines which ad to serve to a device. Various algorithms, proprietary and publically known, can be implemented. In one embodiment, the location and context are taken into account when selecting an ad. Weighting of various factors can vary between implementations. Exemplary factors used for selection include location and context of a user. The location can be a first index to eligible ads while the context refines the selection. A context of a user can include interactions with a device, such as a cell phone. For example, an operating system can track applications opened by a user and specific interactions therein in order to determine a pattern or mood of the user. For example, a user may be standing near restaurants as far as location, and browsing Yelp reviews on an Internet browser application as far as context. As a result, the ad selection unit 124 can further refine ads to address a user context of searching for a nearby restaurant.

The device interface 126 communicates with devices that display ads. The device interface 126 can store separate accounts for each device, or even each user associated with a device. In one embodiment, the device interface 126 receives location and context information. In another embodiment, the device interface 126 serves ads to a web page being viewed by the user (e.g., when using a proxy server or WAP protocol for a mobile device). In yet embodiment, the device interface 126 communicates directly with an ad module integrated in an operating system of a device.

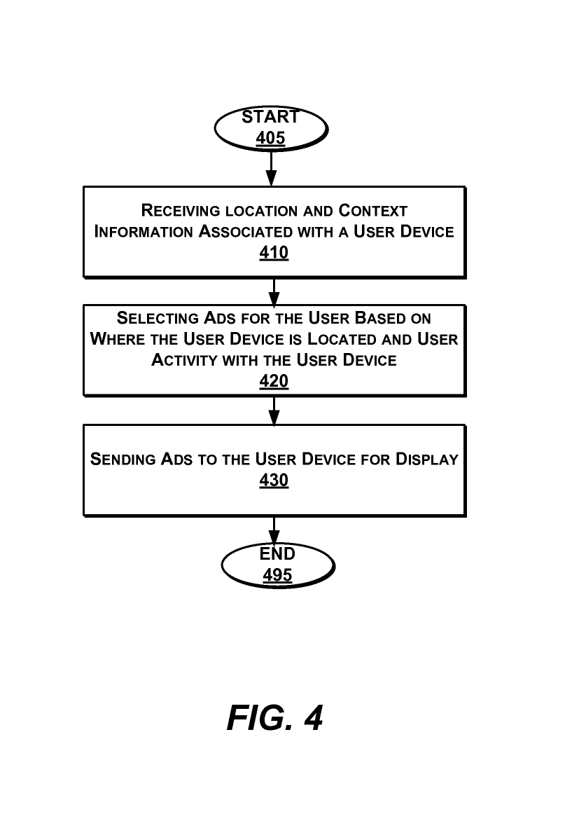

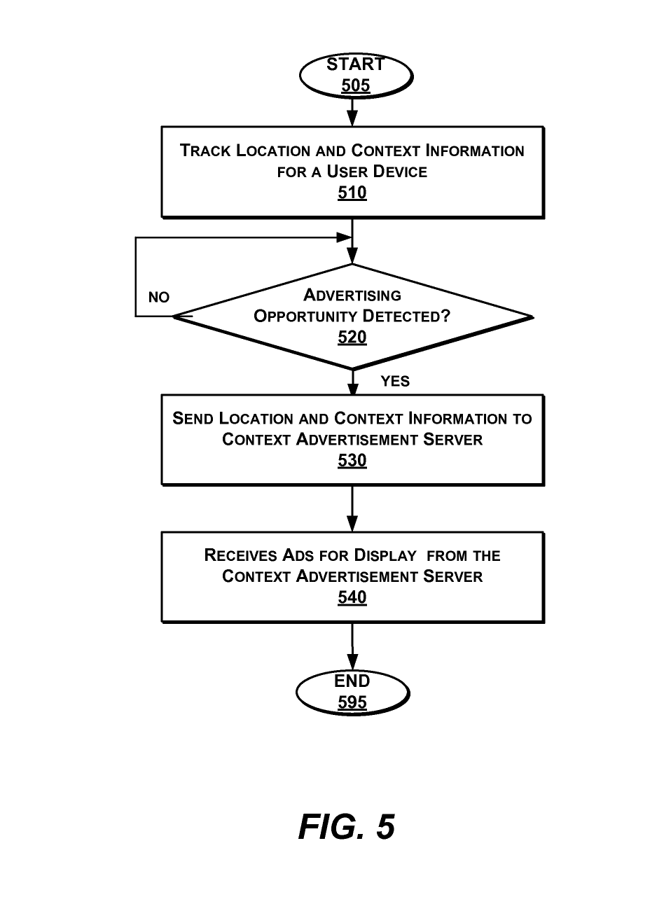

Advertising Methods (FIGS. 4-5)

FIG. 4 is a high-level flow diagram illustrating a method 400 for serving location-aware and context-aware advertisements in a server, according to one embodiment. The method 400 can be implemented, in one embodiment, using the system 100 of FIG. 1. Moreover, the method 400 can be implemented in software, hardware, or a combination of both. The method 400 can be automatically performed (once initialized) without human intervention.

At step 410, location and context information associated with a user device is received. The user device can send location and context information to a server periodically, on demand, or according to any appropriate implementation.

In one example, location information is updated as a user walks through a mall. The location information can reveal a store that the user is currently in as well we nearby stores. Context information is updated as the user interacts with a cell phone or other mobile device.

At step 420, ads for the user are selected based on where the user device is located and use activity with the user device. An algorithm for selecting ads is preferably based on both location and context, to make ads more relevant to what a user is currently experiencing.

In the above example, the user may be closer to clothing stores, but the context information may reveal an appointment to have lunch with a romantic contact. In response, rather than serving ads related to clothing, ads for restaurants can be served. Additionally, an ad for a nearby flower store may also be deemed appropriate for that particular contact.

At step 430, ads are sent to the user device for display. The ads themselves, or references thereto (e.g., identification numbers), can be sent. The ads can be sent in real-time or periodically in batch.

FIG. 5 is a flow diagram illustrating a method 500 for displaying location-aware and context-aware advertisements at a user device, according to one embodiment.

At step 510, location and context information for a user device is tracked. The location information can be determined by GPS, an IP address, cell tower triangulation, from context information, or the like. The context information can be determined by a daemon running on the user device, or by the operating system.

At step 520, if an advertisement opportunity is detected, at step 530, location and context information is sent to a context advertisement server in real-time. Advertisement opportunities can be alternatively determined by a server, which in turn sends a request for location and context information. In other embodiments, location and context information is sent periodically, or when certain applications are opened.

At step 530, ads are received for display from the context advertisement server. Ads can be presented within applications, a desktop, a web browser, a web page on the web browser, printed out, faxed, sent by SMS message, or the like.

Exemplary Computing Device (FIG. 6)

FIG. 6 is a block diagram illustrating an exemplary computing device 600 for use in the system 100 of FIG. 1, according to one embodiment.

The computing device 600, of the present embodiment, includes a memory 610, a processor 620, a storage drive 630, and an I/O port 640. Each of the components is coupled for electronic communication via a bus 699. Communication can be digital and/or analog, and use any suitable protocol.

The memory 610 further comprises an application 612 (as described above) and an operating system 614. Other modules stored in memory can include a web browser application, a web-browser-based application, a mobile application, a streamed application, a locally-installed application, and the like.

The application can be the modules described in FIG. 2. The operating system 614 can be one of the Microsoft Windows® family of operating systems (e.g., Windows 2000, Windows XP, Windows XP x64 Edition, Windows Vista, Widows 7, Windows 8, Windows CE, Windows Mobile), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

The processor 620 can be a video processor, a general purpose processor, an application-specific integrated circuit (ASIC), a field programmable gate array (FPGA), a reduced instruction set controller (RISC) processor, an integrated circuit, or the like. A video processor can be optimized for repeated operations. The processor 620 can be single core, multiple core, or include more than one processing elements. The processor 620 can be disposed on silicon or any other suitable material. The processor 620 can receive and execute instructions and data stored in the memory 610 or the storage drive 630

The storage drive 630 can be any non-volatile type of storage such as a magnetic disc, EEPROM, Flash, or the like. The storage drive 630 stores code and data for applications.

The I/O port 640 further comprises a user interface 642 and a video input 644. The user interface 642 can output to a display device and receive input from, for example, a keyboard. The video input 644 can be a video source or an input such as a video plug.

Many of the functionalities described herein can be implemented with computer software, computer hardware, computer firmware, or a combination.

Computer software products (e.g., non-transitory computer products storing source code) may be written in any of various suitable programming languages, such as C, C++, C#, Java, JavaScript, PHP, Python, Perl, Ruby, and AJAX. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Bluetooth, LTE, Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A computer-implemented method for serving location-based and context-aware advertisements, the method comprising:
receiving location information and context information associated with a user device;
selecting one or more advertisements from a database of advertisements for the user based on where the user device is located and activity of the user with the user device; and
sending the one or more advertisements to the user device for display.

2. The method of claim 1, wherein contextual information comprises activity of the user through the user device.

3. The method of claim 1, further comprising:
approximating characteristics of the user through the contextual information, the characteristics comprising one or more of: intentions, moods, failures, successes, upcoming appointments, and travel plans.

4. The method of claim 1, wherein the location information is determined by a GPS unit associated with the user device.

5. The method of claim 1, wherein the contextual information is collected by either a daemon or an operating system.

6. The method of claim 5, further comprising:
logging applications opened by the user.

7. The method of claim 5, further comprising:
logging input or output of applications opened by the user.

8. The method of claim 1, wherein selecting one or more advertisements comprises:
selecting a first advertisement based on a first location and a first context;
selecting a second advertisement based on the first location and a second context;
selecting a third advertisement based on a second location and the first context; and
selecting a fourth advertisement based on the second location and the second context.

9. The method of claim 1, wherein context information is collected from external to an application.

10. A non-transitory computer-readable medium storing source code that, when executed by a processor, performs a method for serving location-based and context-aware advertisements, the method comprising:
receiving location information and context information associated with a user device;
selecting one or more advertisements from a database of advertisements for the user based on where the user device is located and activity of the user with the user device; and
sending the one or more advertisements to the user device for display.

11. The computer-readable medium of claim 10, wherein contextual information comprises activity of the user through the user device.

12. The computer-readable medium of claim 10, further comprising:
approximating characteristics of the user through the contextual information, the characteristics comprising one or more of: intentions, moods, failures, successes, upcoming appointments, and travel plans.

13. The computer-readable medium of claim 10, wherein the location information is determined by a GPS unit associated with the user device.

14. The computer-readable medium of claim 10, wherein the contextual information is collected by either a daemon or an operating system.

15. The computer-readable medium of claim 14, further comprising:
logging applications opened by the user.

16. The computer-readable medium of claim 14, further comprising:
logging input or output of applications opened by the user.

17. The computer-readable medium of claim 10, wherein selecting one or more advertisements comprises:
selecting a first advertisement based on a first location and a first context;
selecting a second advertisement based on the first location and a second context;
selecting a third advertisement based on a second location and the first context; and
selecting a fourth advertisement based on the second location and the second context.

18. The method of claim 1, wherein context information is collected from external to an application.

19. A user device to serve location-based and context-aware advertisements, comprising:
a processor; and
a memory, comprising:
a GPS unit to determine location information associated with the user device;
a process to determine contextual information associated with the user device from user activity;
selecting one or more advertisements from a database of advertisements for the user based on where the user device is located and activity of the user with the user device; and
sending the one or more advertisements to the user device for display.

20. The user device of claim 19, wherein the computing device comprises a cellular telephone.
